(19) United States
(12) Patent Application Publication
(10) Pub. No.: US 2010/0023580 A1
(43) Pub. Date: Jan. 28, 2010

(54) CONTENT DELIVERY APPARATUS, COMMUNICATION SYSTEM, CONTENT DELIVERY METHOD, AND COMPUTER PRODUCT

(75) Inventors: Eiji HASEGAWA, Kawasaki (JP); Hironori SAKAKIHARA, Kawasaki (JP); Fumio HONDA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/501,087

(22) Filed: Jul. 10, 2009

(30) Foreign Application Priority Data
Jul. 24, 2008 (JP) 2008-191346

(51) Int. Cl. G06F 15/16

(52) U.S. Cl. 709/203; 709/217

(57) ABSTRACT

A content delivery apparatus and method operable to access a network, to which a content management apparatus and a content acquiring apparatus are connected, where the content delivery apparatus accepts content delivery request(s). The content delivery apparatus obtains a number of content delivery apparatus(es) having the same content on the network, and a number of times that the content management apparatus has accepted inquiries regarding content holding status(es) from content acquiring apparatuses, and calculates a delivery priority by dividing a number of requests by the number of content holding apparatuses. The content delivery apparatus, when the delivery request accepting section accepts the delivery requests for a plurality of contents, delivers the plurality of contents preferentially from a content having a high delivery priority.

### CROSS-REFERENCE TO RELATED APPLICATIONS

This application claims the benefit of priority from Japanese Patent Application No. 2008-191346 filed on Jul. 24, 2008, which is herein incorporated by reference in its entirety.

### BACKGROUND

1. Field

The present invention relates to a content delivery apparatus, a communication system, a content delivery method, and a computer product capable of delivering recorded content to a content acquiring apparatus upon receiving a content delivery request from the content acquiring apparatus.

2. Description of the Related Art

As one form of a computer network, a client server model is generally employed in which roles are allocated to a server taking charge of executing particular process(es) requested by a client and to clients operated by users, and in which the server and the clients are interconnected via a network.

In such a client server model, processing is performed such that each client sends a “request” to the server and the server replies a “response” to the client.

Recently, with widespread use of always-on broadband lines, an improvement in processing performance of personal computers, and an increase in capacity of hard disks, a P2P (Peer to Peer) model, i.e., an architecture requiring no servers, has been proposed instead of the client server model that has the problem of bottle-neck attributable to the use of the server (see Japanese Patent Laid-Open No. 2005-135140).

In the P2P model, computers participating in a network play equal or similar roles on an equivalent basis such that particular resources are not concentrated on a particular computer.

In a P2P system (communication system) embodying the P2P model, because content is delivered and acquired among the computers participating in the network, it is difficult to optimize delivery efficiency in the entire P2P system.

However, the following various methods (first to third methods), for example, have recently been proposed to increase the delivery efficiency in the entire P2P system.

With the first method, when a content delivery apparatus holding content therein accepts a content delivery request from each of a plurality of content acquiring apparatuses, the content delivery apparatus delivers the content to the content acquiring apparatus having a maximum transfer rate with the highest priority.

Herein, the content delivery apparatus is a computer capable of delivering content recorded (held) therein.

Also, the content acquiring apparatus is a computer desiring to acquire content.

As a result, the computer holding the content therein can be caused to participate in the P2P system at earlier timing, and a load of the content delivery apparatus can be distributed.

Therefore, the delivery efficiency in the entire P2P system can be increased.

With the second method, the content acquiring apparatus sends the content delivery request to one of a plurality of content delivery apparatuses each holding content therein, which is in the best communication state (in terms of delivery quality) (see Japanese Patent Laid-Open No. 2005-135140).

Accordingly, the content acquiring apparatus can acquire the content from the content delivery apparatus in the best communication state.

Hence, the delivery efficiency in the entire P2P system can be increased.

With the third method, when a content delivery apparatus holding plural kinds of contents therein accepts a plurality of delivery requests from a plurality of content acquiring apparatuses, the content delivery apparatus first obtains content information from a center server.

Herein, the content information includes popularity data representing a popularity level of content, and release day data representing the release day of the content.

The content delivery apparatus delivers the content, which has a higher popularity level and is closer to the release day, to the content acquiring apparatus with higher priority (see Japanese Patent Laid-Open No. 2007-87280).

As a result, the content having higher popularity and being closer to the release day can be delivered with higher priority.

### SUMMARY

A content delivery apparatus, disclosed in the following detailed description, is operable to access a network to which a content management apparatus and a content acquiring apparatus are connected.

The content delivery apparatus includes a content recording section in which one or more contents are recorded in advance, and a delivery request accepting section for accepting a content delivery request from the content acquiring apparatus.

The content delivery apparatus further includes a delivery priority calculating section for obtaining, from the content management apparatus or the content acquiring apparatus, a number of content holding apparatuses, which represents a number of content delivery apparatuses recording the same content on the network, and a number of requests, which represents a number of times that the content management apparatus has accepted inquiries regarding content holding statuses from the content acquiring apparatuses, and for calculating a delivery priority, which is obtained based on a value calculated by dividing the number of requests by the number of content holding apparatuses, with respect to the content for which the delivery request accepting section has accepted the delivery request.

The content delivery apparatus may include a content delivery section for, when a delivery request accepting section accepts the delivery requests for a plurality of contents, delivering the plurality of contents prefentially from the content having the high delivery priority.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of a P2P system according to an embodiment of the present invention;

FIG. 2 illustrates one example of content holding information recorded in a content management apparatus;

FIG. 3 illustrates one example of content holding information recorded in a content management apparatus;

FIG. 4 illustrates one example of content related information recorded in a content related information recording section of a content management apparatus;

FIG. 5 illustrates one example of content related information recorded in a content management apparatus;

FIG. 6 illustrates one example of content related information recorded after a related information updating section has added “1” to each of a number of content holding apparatuses and a number of requests accepted on a current day;

FIG. 7 illustrates one example of content related information recorded in a content related information recording section after a related information updating section has added “1” to each of the number of content holding apparatuses and a number of requests accepted on a current day;

FIG. 8 is a flowchart illustrating an example of operation of the P2P system from sending of a notification request from a content acquiring apparatus to a content management apparatus to sending of a delivery request from a content acquiring apparatus to a content delivery apparatus;

FIG. 9 is a flowchart illustrating an example of operation of the P2P system when a content delivery apparatus has accepted a delivery request sent from a content acquiring apparatus;

FIG. 10 is a block diagram of a P2P system according to an embodiment of the present invention;

FIG. 11 illustrates one example of content related information recorded in a content management apparatus;

FIG. 12 illustrates one example of content related information recorded in a content management apparatus; and

FIG. 13 is a block diagram to explain problem(s) with a typical P2P system.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

The conventional methods have disadvantage(s) including with lower delivery efficiency in the entire P2P system, for example, in the following case.

That is, the delivery efficiency in the entire P2P system lowers when a number of content acquiring apparatuses going to acquire content is relatively large in comparison with a number of content delivery apparatus holding the content.

In such a situation, it often takes a good amount of time until the content acquiring apparatus acquires the content from the content delivery apparatus.

That point will be described in more detail below.

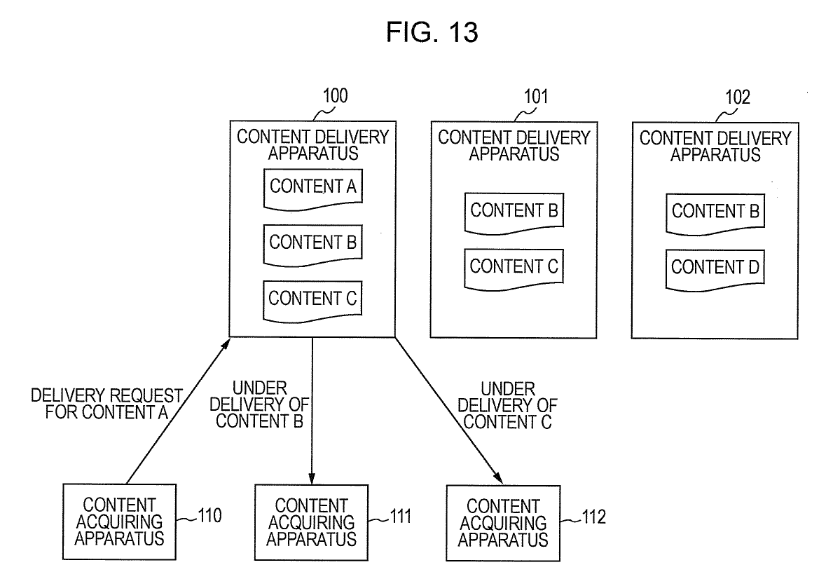

Assume the case where there are three content delivery apparatuses 100 to 102 and three content acquiring apparatuses 110 to 112, for example, as illustrated in FIG. 13.

It is here assumed that the content delivery apparatus 100 holds contents A to C, the content delivery apparatus 101 holds contents B and C, and the content delivery apparatus 102 holds contents B and D.

Further, it is assumed that the content delivery apparatus 100 is under delivery of the content B to the content acquiring apparatus 111.

Still further, it is assumed that the content delivery apparatus 100 is under delivery of the content C to the content acquiring apparatus 112.

In addition, it is assumed that the content acquiring apparatus 110 sends a delivery request for the content A to the content delivery apparatus 100 in order to acquire the content A.

In that case, while the content delivery apparatus 100 accepts the delivery request for the content A from the content acquiring apparatus 110, the content delivery apparatus 100 usually notifies a standby instruction to the content acquiring apparatus 110 because it is currently under delivery of the contents B and C.

Therefore, the content acquiring apparatus 110 stands by until the content delivery apparatus 100 completes the delivery of the contents B and C.

Herein, because the content delivery apparatus holding the content A is only one, i.e., the content delivery apparatus 100, the content acquiring apparatus 110 has to acquire the content A from the content delivery apparatus 100.

However, because there are three content delivery apparatuses each holding the content B, i.e., the content delivery apparatuses 100 to 102, the content acquiring apparatus 111 is not necessarily required to acquire the content B from the content delivery apparatus 100.

Similarly, the content acquiring apparatus 112 is not necessarily required to acquire the content C from the content delivery apparatus 100.

In particular, when the delivery request for the content A is sent to the content delivery apparatus 100 from each of a plurality of content acquiring apparatuses including the content acquiring apparatus 110, the delivery efficiency in the entire P2P system could be increased if the content acquiring apparatus 111 acquires the content B from the content delivery apparatus 102 and the content acquiring apparatus 112 acquires the content C from the content delivery apparatus 101.

With the typical methods, however, delivery priority is determined in consideration of only the transfer rate and the communication state of the network. For that reason, the delivery efficiency in the entire P2P system cannot be increased in the above-described case.

Also, with the typical methods, the content having a higher popularity level and being closer to the release day is delivered to the content acquiring apparatus with higher priority. For that reason, the delivery efficiency in the entire P2P system cannot also be increased in the above-described case.

More specifically, with the typical methods, because the number of content delivery apparatuses holding the content B is maximum (i.e., three content delivery apparatuses 100 to 102), the content having the highest popularity level among the contents A to D is the content B.

This means that the content B is delivered with top priority. Therefore, the content acquiring apparatus 110 has to stand by until the delivery of the content B from the content delivery apparatus 100 is completed.

A content delivery apparatus disclosed herein is to solve the above-described and other problems and to improve performance including increasing the delivery efficiency in an entire communication system.

According to one embodiment of the present invention, in a content delivery apparatus connected to a network to which a content management apparatus and a content acquiring apparatus are connected, the content delivery apparatus comprises a content recording section in which one or more contents are recorded in advance. A delivery request accepting section for accepting a content delivery request from the content acquiring apparatus and a delivery priority calculating section is provided. A number of content holding apparatuses, which represents the number of content delivery apparatuses recording the same content on the network, and a number of requests, which represents the number of times that the content management apparatus has accepted inquiries regarding content holding statuses from the content acquiring apparatuses, is obtained and a delivery priority is calculated based on a value calculated by dividing the number of requests by the number of content holding apparatuses, with respect to the content for which the delivery request accepting section has accepted the delivery request. A content delivery section is provided for, when the delivery request accepting section accepts the delivery requests for a plurality of contents, delivering the plurality of contents successively from the content having the highest delivery priority in the descending order of the priority.

Further, embodiments of the present invention are provided as a communication system, a content delivery method, and a computer readable medium having a program, which are implemented based on substantially the same technical concepts as those described above.

With the above-described configuration, a delivery priority calculating section calculates the delivery priority, which is obtained based on a value calculated by dividing the number of requests by the number of content; holding apparatuses, with respect to the content for which the delivery request accepting section has accepted the delivery request.

The term “number of content holding apparatuses” refers to a number of content delivery apparatus(es) recording (containing) the same content on the network.

The term “number of requests” refers to a number of times that the content management apparatus has accepted inquir(ies) regarding content holding status(es) from the content acquiring apparatus(es).

In other words, the delivery priority becomes higher as the number of requests increases relative to the number of content holding apparatuses.

When the delivery request accepting section accepts the delivery requests for a plurality of contents, the content delivery section delivers the plurality of contents successively from the content having the highest delivery priority in the descending order of the priority.

Thus, since the content for which the number of requests is larger relative to the number of content holding apparatuses is delivered with higher priority when the delivery request accepting section accepts the delivery requests for the plurality of contents, the delivery efficiency in the entire communication system can be increased.

According to another embodiment of the present invention, in a content delivery apparatus connected to a network to which a content management apparatus and a content acquiring apparatus are connected, the content delivery apparatus comprises a content recording section in which one or more contents are recorded in advance, and a delivery request accepting section for accepting a content delivery request from the content acquiring apparatus. A delivery priority calculating section is provided for obtaining, from the content management apparatus or the content acquiring apparatus, a total delivery rate which represents a total of respective content delivery rates of content delivery apparatuses recording the same content on the network, and a number of requests, which represents a number of times that the content management apparatus has accepted inquiries regarding content holding statuses from the content acquiring apparatuses, and for calculating a delivery priority, which is obtained based on a value calculated by dividing the number of requests by the total delivery rate, with respect to the content for which the delivery request accepting section has accepted the delivery request. A content delivery section, when the delivery request accepting section accepts the delivery requests for a plurality of contents, delivers the plurality of contents successively from the content having the highest delivery priority in the descending order of the priority.

Further, embodiments of the present invention are provided as a communication system, a content delivery method, and a computer readable medium program, which are implemented based on substantially the same technical concepts as those described above.

With the above-described configuration, the delivery priority calculating section calculates the delivery priority, which is obtained based on a value calculated by dividing a number of requests by a total delivery rate, with respect to the content for which the delivery request accepting section has accepted the delivery request.

The term “total delivery rate” refers to a total of respective content delivery rates of the content delivery apparatuses recording the same content on the network.

The term “number of requests” refers to a number of times that the content management apparatus has accepted the inquiries regarding content holding statuses from the content acquiring apparatuses.

In other words, the delivery priority becomes higher as the number of requests increases relative to the total delivery rate.

When the delivery request accepting section accepts the delivery requests for a plurality of contents, the content delivery section delivers the plurality of contents successively from the content having the highest delivery priority in the descending order of the priority.

Thus, since the content for which the number of requests is larger relative to the total delivery rate is delivered with higher priority when the delivery request accepting section accepts the delivery requests for the plurality of contents, the delivery efficiency in the entire communication system can be increased.

In the embodiment of the present invention, preferably, the content acquiring apparatus having acquired the content delivered from the content delivery section sends a completion report, which indicates completion of the acquisition of the content, to the content management apparatus to which the inquiry regarding the content holding status has been sent from the relevant content acquiring apparatus, and the number of requests represents the number of times that the content management apparatus has accepted the inquiries regarding the content holding statuses from the content acquiring apparatuses, for which the content management apparatus does not yet received the completion reports from the content acquiring apparatuses in spite of having accepted the inquiries from the relevant content acquiring apparatuses.

The term “number of requests” used herein represents a number of request(s) accepted from the content acquiring apparatuses which are currently in a state of acquiring the content.

Therefore, the delivery priority calculating section can calculate the delivery priority based on a number of request(s) accepted from the content acquiring apparatuses which are currently in a state of acquiring the content.

Embodiments of the present invention will be described in detail below with reference to the drawings.

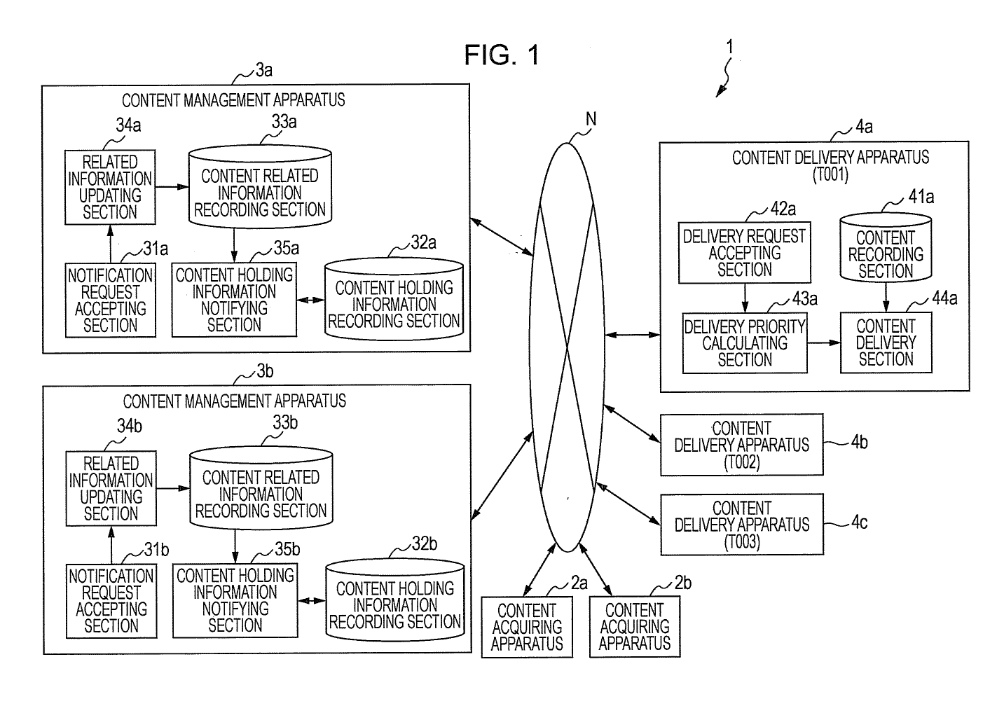

FIG. 1 is a block diagram of a P2P (Peer to Peer) system (communication system) 1 according to an embodiment.

More specifically, the P2P system 1 according to this embodiment includes content acquiring apparatuses 2a and 2b, content management apparatuses 3a and 3b, and content delivery apparatuses 4a to 4c.

While, in this embodiment, the content acquiring apparatuses 2a and 2b, the content management apparatuses 3a and 3b, and the content delivery apparatuses 4a to 4c are each a universal computer, the embodiment is not limited to the use of a universal computer. Those apparatuses may be each, for example, a PDA (Personal Digital Assistant), a cell phone, or a household electrical appliance (e.g., a TV set, a printer, a digital camera, an air conditioner, or a refrigerator).

The content acquiring apparatuses 2a and 2b, the content management apparatuses 3a and 3b, and the content delivery apparatuses 4a to 4c are connected to a network N.

The network N is, e.g., the Internet. The content acquiring apparatuses 2a and 2b, the content management apparatuses 3a and 3b, and the content delivery apparatuses 4a to 4c are capable of communicating with each other according to the preset protocol, e.g., TCP/IP (Transmission Control Protocol/Internet Protocol) or UDP/IP (User Datagram Protocol/Internet Protocol).

Instead of the Internet, the network N may be, for example, the Ethernet (registered trademark), a home network, or a wireless LAN.

For the sake of explanation, FIG. 1 illustrates two content acquiring apparatuses 2a and 2b, two content management apparatuses 3a and 3b, and three content delivery apparatuses 4a to 4c. It is assumed, however, that the content acquiring apparatus, the content management apparatus, and the content delivery apparatus constituting the P2P system 1 according to this embodiment are each present in number equal to or more than the number illustrated in FIG. 1.

Also, in this embodiment, terminal IDs for identifying the content delivery apparatuses 4a to 4c are denoted by “T001” to “T003”, respectively, as illustrated in FIG. 1.

In the following description as to components having the same function, each component is denoted by suffixing a small alphabetic letter to a corresponding reference numeral, such as the content acquiring apparatus 2a, to distinguish individual components only when the individual components are required to be particularly distinguished from each other. When the individual components are not required to be particularly distinguished from each other, or when they are collectively referred to, each component is denoted by not suffixing a small alphabetic letter, such as the content acquiring apparatus 2.

The content acquiring apparatus 2 is a computer that is going to acquire content (i.e., that desires to acquire content).

Herein, the term “content” refers to any data including but not limited to text, a still image, a moving image, music, or combination thereof.

In this embodiment, the content acquiring apparatus 2a is a computer desiring to acquire content A, and the content acquiring apparatus 2b is a computer desiring to acquire content B.

Therefore, the content acquiring apparatus 2a sends a request for notifying content holding information to identify a content delivery apparatus, which holds the content A, to the content management apparatus 3a through the network N.

Also, the content acquiring apparatus 2b sends a request for notifying content holding information to identify a content delivery apparatus, which holds the content B, to the content management apparatus 3b through the network N.

Stated another way, in this embodiment, the content management apparatus 3a serves as a management apparatus for the content A, and the content management apparatus 3b serves as a management apparatus for the content B.

One or more of the computers present in the P2P system 1 are selected as the content management apparatuses by using the known DHT (Distributed Hash Table) method.

More specifically, the content acquiring apparatus 2 calculates a Hash value by applying the Hash function to the content ID of the desired content, and determining, as the content management apparatus 3 for the desired content, the computer having the terminal ID of which Hash value is closest to the calculated Hash value.

In such a manner, the content acquiring apparatus 2 can specify the content management apparatus 3 for the desired content on the P2P system 1.

The content management apparatus 3 includes a notification request accepting section 31, a content holding information recording section 32, a content related information recording section 33, a related information updating section 34, and a content holding information notifying section 35.

Herein, respective function(s) of the notification request accepting section 31, the related information updating section 34, and the content holding information notifying section 35 are realized with a processor, such as a CPU of the computer, executing given program(s). However, any or all of the functions(s) of the content management apparatus 3 and/or other apparatuses described herein may be implemented via one or more hardware components.

Accordingly, the programs for realizing those functions with the computer and a recording medium recording the programs also constitute embodiments of the present invention.

Further, the content holding information recording section 32 and the content related information recording section 33 are implemented by a storage device built in the computer or a storage device accessible from the computer.

The notification request accepting section 31 accepts the notification request sent from the content acquiring apparatus 2 through the network N.

The notification request accepting section 31 outputs the accepted notification request to the related information updating section 34.

The content holding information recording section 32 records the content holding information to identify the content delivery apparatus that holds some content.

In more detail, the content holding information recording section 32 records, in a correspondent relation, a content ID to identify some content and a terminal ID of the content delivery apparatus holding the relevant content.

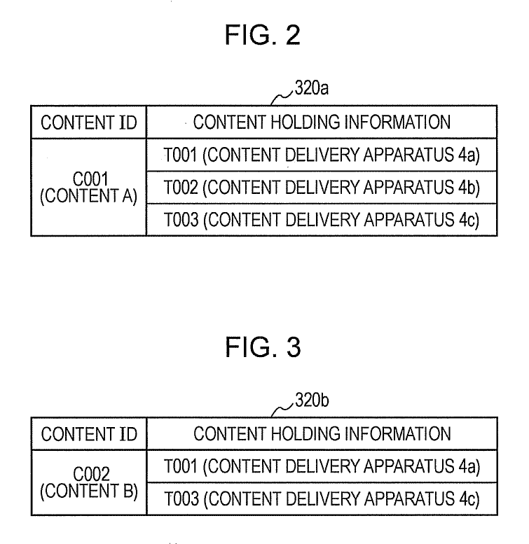

FIG. 2 illustrates one example of content holding information recorded in the content holding information recording section 32a of the content management apparatus 3a according to an embodiment.

In other words, the content holding information recording section 32a according to an embodiment records the content holding information in the form of a table 320a.

As illustrated in FIG. 2, the table 320a records, in a correspondent relation, the content ID “C001” of the content A and the terminal IDs “T001” to “T003” of the content delivery apparatuses 4a to 4c each holding the content A.

FIG. 3 illustrates one example of content holding information recorded in the content holding information recording section 32b of the content management apparatus 3b according to an embodiment.

More specifically, the content holding information recording section 32b according to an embodiment records the content holding information in the form of a table 320b.

As illustrated in FIG. 3, the table 320b records, in a correspondent relation, the content ID “C002” of the content B and the terminal IDs “T001” and “T003” of the content delivery apparatuses 4a and 4c each holding the content B.

The content related information recording section 33 records the content related information.

Herein, the content related information includes a number of content holding apparatuses, which represents a number of content delivery apparatuses holding (recording) the same content on the network N, and a number of requests, which represents a number of times that the notification request accepting section 31 has accepted inquiries regarding content holding statuses from the content acquiring apparatuses 2. Content holding apparatus(es) are not limited to being the same components delivering the content.

The term “number of requests” in an embodiment refers to a number of times that the notification request accepting section 31 has accepted inquiries from the content acquiring apparatuses 2 within a given period.

Stated another way, the content related information recording section 33 records, in a correspondent relation, content ID, a number of content holding apparatuses, and a number of requests.

While, in this embodiment, the given period is three days, i.e., today, yesterday, and the day before yesterday, it is a matter of courts that the given period is not limited to those three days.

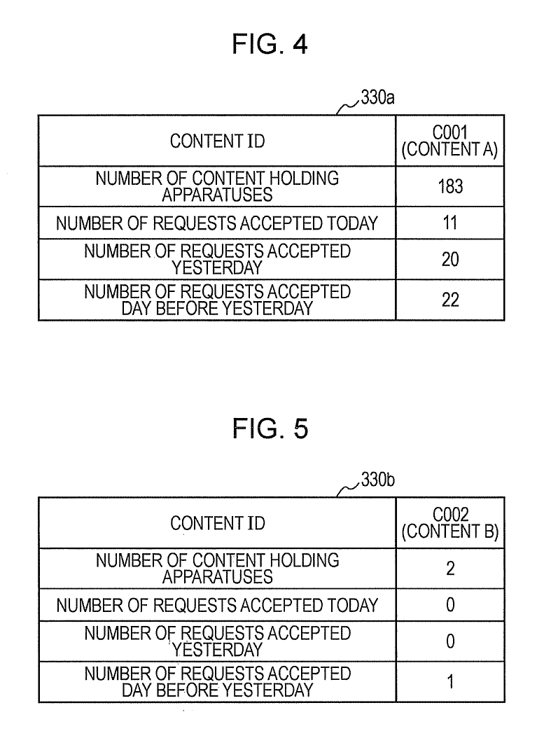

FIG. 4 illustrates one example of content related information recorded in the content related information recording section 33a of the content management apparatus 3a according to an embodiment.

More specifically, the content related information recording section 33a according to an embodiment records the content related information in the form of a table 330a.

As illustrated in FIG. 4, the table 330a records the content ID “C001” of the content A, the number “183” of content holding apparatuses, which represents the number of content delivery apparatuses each holding the content A, the number “11” of requests accepted today (a current day), the number “20” of requests accepted yesterday, and the number “22” of requests accepted the day before yesterday.

Stated another way, the table 330a indicates that there are 183 content delivery apparatuses each holding the content A on the P2P system 1, and the numbers of times that the notification request accepting section 31a has accepted the notification requests for three days, i.e., today, yesterday, and the day before yesterday, from the content acquiring apparatuses 2 are “11”, “20” and “22”, respectively.

FIG. 5 illustrates one example of content related information recorded in the content related information recording section 33b of the content management apparatus 3b according to an embodiment.

More specifically, the content related information recording section 33b according to an embodiment records the content related information in the form of a table 330b.

As illustrated in FIG. 5, the table 330b records the content ID “C002” of the content B, the number “2” of content holding apparatuses, which represents the number of content delivery apparatuses each holding the content B, the number “0” of requests accepted today, the number “0” of requests accepted yesterday, and the number “1” of requests accepted the day before yesterday.

Stated another way, the table 330b indicates that there are two content delivery apparatuses each holding the content B on the P2P system 1, and the numbers of times that the notification request accepting section 31b has accepted the notification requests for three days, i.e., today, yesterday, and the day before yesterday, from the content acquiring apparatuses 2 are “0”, “0” and “1”, respectively.

While the content holding information recording section 32 and the content related information recording section 33 have been described above, by way of example, as recording the content holding information and the content related information in the form of tables, those recording sections are not limited to the above-described examples.

Thus, the forms adapted for recording the content holding information and the content related information, respectively, in the content holding information recording section 32 and the content related information recording section 33 are not limited to tables and can be optionally selected.

The related information updating section 34 updates the content related information recorded in the content related information recording section 33 in accordance with the notification request accepted by the notification request accepting section 31.

More specifically, the related information updating section 34 adds “1” to the number of content holding apparatuses and also adds “1” to the number of requests accepted today, which are recorded in the content related information recording section 33, in accordance with the notification request accepted by the notification request accepting section 31.

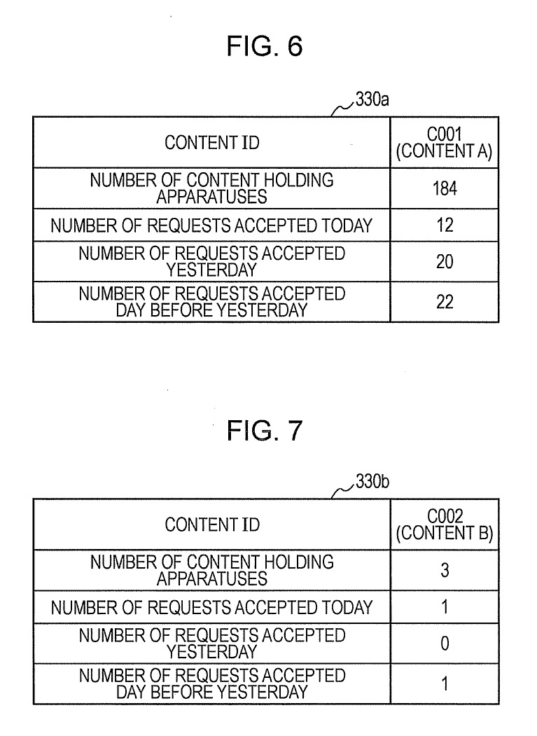

FIG. 6 illustrates one example of content related information recorded in the content related information recording section 33a after the related information updating section 34a has added “1” to each of the number of content holding apparatuses and the number of requests accepted today.

More specifically, in the table 330a illustrated in FIG. 6, the number of content holding apparatuses is updated from “183” to “184” and the number of requests accepted today is updated from “11” to “12” in comparison with the table 330a illustrated in FIG. 4.

FIG. 7 illustrates one example of content related information recorded in the content related information recording section 33b after the related information updating section 34b has added “1” to each of the number of content holding apparatuses and the number of requests accepted today.

More specifically, in the table 330b illustrated in FIG. 7, the number of content holding apparatuses is updated from “2” to “3” and the number of requests accepted today is updated from “0” to “1” in comparison with the table 330b illustrated in FIG. 5.

The content holding information notifying section 35 reads out, from the content holding information recording section 32, an arbitrary number of sets of the content holding information recorded in the content holding information recording section 32, when the related information updating section 34 updates the content related information.

In other words, the content holding information notifying section 35 may read out, from the content holding information recording section 32, all sets of the content holding information recorded in the content holding information recording section 32, or part (one or plural sets) of the content holding information recorded in the content holding information recording section 32.

In an embodiment, the content holding information notifying section 35 reads out, from the content holding information recording section 32, an arbitrary number of sets of the content holding information which have been selected at random from among all sets of the content holding information recorded in the content holding information recording section 32.

Concretely, the content holding information notifying section 35a of the content management apparatus 3a reads out, from the content holding information recording section 32a, two sets of the content holding information “T001” and “T002” which have been selected at random from among all sets of the content holding information “T001” to “T003” recorded in the content holding information recording section 32a.

The content holding information notifying section 35a notifies, to the content acquiring apparatus 2a, the read-out content holding information “T001” and “T002” along with the number “184” of content holding apparatuses and the respective numbers of requests for three days (i.e., “12” accepted today, “20” accepted yesterday, and “22” accepted the day before yesterday), which are recorded in the content related information recording section 33a.

As a result, the content acquiring apparatus 2a can confirm that the content delivery apparatuses holding the content A on the P2P system 1 are the content delivery apparatus 4a and the content delivery apparatus 4b.

Also, the content holding information notifying section 35b of the content management apparatus 3b reads out, from the content holding information recording section 32b, one set of the content holding information “T001” which has been selected at random from among all sets of the content holding information “T001” and “T002” recorded in the content holding information recording section 32b.

The content holding information notifying section 35b notifies, to the content acquiring apparatus 2b, the read-out content holding information “T001” along with the number “3” of content holding apparatuses and the respective numbers of requests for three days (i.e., “1” accepted today, “0” accepted yesterday, and “1” accepted the day before yesterday), which are recorded in the content related information recording section 33b.

As a result, the content acquiring apparatus 2b can confirm that the content delivery apparatus holding the content B on the P2P system 1 is the content delivery apparatus 4a.

Further, the content holding information notifying section 35 rewrites data in the content holding information recording section 32 so that the terminal ID of the content acquiring apparatus 2 having sent the notification request is provided as the content holding information.

As a result, the terminal ID of the content acquiring apparatus 2a is newly recorded, as the content holding information, in the content holding information recording section 32a according to an embodiment in addition to the terminal IDs “T001” to “T003” of the content delivery apparatuses 4a to 4c.

Also, the terminal ID of the content acquiring apparatus 2b is newly recorded, as the content holding information, in the content holding information recording section 32b according to an embodiment in addition to the terminal IDs “T001” and “T003” of the content delivery apparatuses 4a and 4c.

The content acquiring apparatus 2 obtains the content holding information, the number of content holding apparatuses, and the number of requests, which have been notified from the content management apparatus 3 through the network N.

In an embodiment, the content acquiring apparatus 2a obtains the content holding information “T001” and “T002”, the number “184” of content holding apparatuses, and the numbers of requests (i.e., “12” accepted today, “20” accepted yesterday, and “22” accepted the day before yesterday), which have been notified from the content management apparatus 3a.

Also, the content acquiring apparatus 2b obtains the content holding information “T001”, the number “3” of content holding apparatuses, and the numbers of requests (i.e., “1” accepted today, “0” accepted yesterday, and “1” accepted the day before yesterday), which have been notified from the content management apparatus 3b.

The content acquiring apparatus 2 sends, based on the obtained content holding information, a content delivery request to the content delivery apparatus 4 along with the obtained number of content holding apparatuses and numbers of requests.

If the content acquiring apparatus 2 obtains plural sets of the content holding information, the content acquiring apparatus 2 sends a content delivery request to the content delivery apparatus 4 based on one set of the content holding information, which has been selected in accordance with a given rule, along with the obtained number of content holding apparatuses and numbers of requests.

In an embodiment, the content acquiring apparatus 2a sends a delivery request for the content A to the content delivery apparatus 4a based on the content holding information “T001”, which has been selected in accordance with the given rule, along with the number “184” of content holding apparatuses and the numbers of requests (i.e., “12” accepted today, “20” accepted yesterday, and “22” accepted the day before yesterday).

Also, the content acquiring apparatus 2b sends a delivery request for the content B to the content delivery apparatus 4a based on the content holding information “T001”, along with the number “3” of content holding apparatuses and the numbers of requests (i.e., “1” accepted today, “0” accepted yesterday, and “1” accepted the day before yesterday).

The content delivery apparatus 4a includes a content recording section 41a, a delivery request accepting section 42a, a delivery priority calculating section 43a, and a content delivery section 44a (FIG. 1).

Note that each of the content delivery apparatuses 4b and 4c also has the same configuration as that of the content delivery apparatus 4a.

More specifically, although not illustrated, the content delivery apparatuses 4b and 4c include respectively content recording sections 41a and 41b, delivery request accepting sections 42a and 42b, delivery priority calculating sections 43a and 43b, and content delivery sections 44a and 44b.

Herein, respective function(s) of the delivery request accepting section 42a, the delivery priority calculating section 43, and the content delivery section 44 are realized with a processor, such as a CPU of the computer, executing given programs.

Accordingly, the program(s) for realizing those functions with the computer and a recording medium recording the programs also constitute embodiments of the present invention.

Further, the content recording section 41 is implemented by a storage device built in the computer or a storage device accessible from the computer.

A plurality of contents are previously recorded in the content recording section 41.

In an embodiment, the content A and the content B are previously recorded in the content recording section 41a of the content delivery apparatus 4a.

The delivery request accepting section 42 accepts a plurality of delivery requests, which are sent from a plurality of content acquiring apparatuses, along with the respective numbers of content holding apparatuses and numbers of requests.

In an embodiment, the delivery request accepting section 42a accepts the delivery request for the content A, which has been sent from the content acquiring apparatus 2a, along with the number “184” of content holding apparatuses and the numbers of requests (i.e., “12” accepted today, “20” accepted yesterday, and “22” accepted the day before yesterday).

Also, the delivery request accepting section 42a accepts the delivery request for the content B, which has been sent from the content acquiring apparatus 2b, along with the number “3” of content holding apparatuses and the numbers of requests (i.e., “1” accepted today, “0” accepted yesterday, and “1” accepted the day before yesterday).

The delivery request accepting section 42 outputs, to the delivery priority calculating section 43, the accepted delivery requests, numbers of content holding apparatuses, and numbers of requests.

The content delivery apparatus 4 may record the numbers of content holding apparatuses and the numbers of requests, which have been accepted by the delivery request accepting section 42, in an internal memory (not illustrated) in a correspondent relation to the plurality of contents recorded in the content recording section 41.

The delivery priority calculating section 43 calculates delivery priority, which is obtained based on a value calculated by dividing the number of requests by the number of content holding apparatuses, with respect to the content for which the delivery request accepting section 42 has accepted the delivery request.

Concretely, the delivery priority calculating section 43 calculates the delivery priority in accordance with a formula (1) given below.

The delivery priority expressed by the following formula (1) becomes higher as the number of requests increases relative to the number of content holding apparatuses.

While, in the following formula (1), the total sum of the number of requests for three days is used as a numerator of the formula expressing the delivery priority, the calculation formula is not limited to (1).

For example, only the number of requests accepted today may be used as the numerator of the formula expressing the delivery priority, or only the number of requests accepted in the forenoon of today may be used as the numerator of the formula expressing the delivery priority.

In other words, the numerator of the formula expressing the delivery priority can be arbitrarily selected so long as it is provided by the number of requests accepted for a given period.

Alternatively, the delivery priority may be calculated by multiplying the following formula (1) by some coefficient (correction coefficient).

Delivery priority=(number of requests accepted today+number of requests accepted yesterday+number of requests accepted the day before yesterday)÷(number of content holding apparatuses) (1)

Concretely, the delivery priority calculating section 43a calculates the delivery priority “0.293” of the content A by substituting the number “184” of content holding apparatuses and the numbers of requests (i.e., “12” accepted today, “20” accepted yesterday, and “22” accepted the day before yesterday) into the formula (1).

Further, the delivery priority calculating section 43a calculates the delivery priority “0.667” of the content B by substituting the number “3” of content holding apparatuses and the numbers of requests (i.e., “1” accepted today, “0” accepted yesterday, and “1” accepted the day before yesterday) into the formula (1).

The delivery priority calculating section 43 outputs the calculated delivery priority to the content delivery section 44.

When the delivery request accepting section 42 accepts the delivery requests for a plurality of contents, the content delivery section 44 delivers the plurality of contents successively from the content having the highest delivery priority in the descending order of the priority.

In more detail, the content delivery section 44 reads out the content having higher delivery priority from the content recording section 41 and sends the read-out content to the content acquiring apparatus 2 which has sent the content delivery request.

In this embodiment, the delivery priority “0.667” of the content B is higher than the delivery priority “0.293” of the content A.

Therefore, the content delivery section 44a according to an embodiment first reads out the content B from the content recording section 41a and delivers the read-out content B to the content acquiring apparatus 2b which has sent the delivery request for the content B.

After completion of the delivery of the content B to the content acquiring apparatus 2b, the content delivery section 44a reads out the content A from the content recording section 41a and delivers the read-out content A to the content acquiring apparatus 2a which has sent the delivery request for the content A.

Thus, since the content delivery section 44 delivers the content, for which the number of requests is larger relative to the number of content holding apparatuses, with higher priority, the delivery efficiency in the entire P2P system 1 can be increased.

Upon acquiring the content B delivered from the content delivery section 44a, the content acquiring apparatus 2b sends, to the content management apparatus 3b, a completion report indicating that the acquisition of the content B has completed.

Also, upon acquiring the content A delivered from the content delivery section 44a, the content acquiring apparatus 2a sends, to the content management apparatus 3a, a completion report indicating that the acquisition of the content A has completed.

As a result, the content management apparatus 3 can confirm that the relevant content acquiring apparatuses 2 have completed the acquisition of the respective contents.

The following description is made for the case where the delivery request accepting section 42a accepts the delivery request for the content B from the content acquiring apparatus 2b in the state of the content delivery section 44a being under delivery of the content A to the content acquiring apparatus 2a.

In such a case, it is also assumed that the delivery priority of the content A is “0.293” and the delivery priority of the content B is “0.667”.

Because the delivery priority “0.667” of the content B is higher than the delivery priority “0.293” of the content A, the content delivery section 44a stops the delivery of the content A to the content acquiring apparatus 2a.

On that occasion, the content delivery section 44a notifies the content acquiring apparatus 2a of the fact that the delivery of the content A has been stopped.

That notification includes a resumption time at which the delivery of the content A is expected to be resumed.

Accordingly, the content acquiring apparatus 2a can confirm the stop of the delivery of the content A and the resumption time at which the delivery of the content A is expected to be resumed.

Here, if the content acquiring apparatus 2a determines that the resumption time is too far from a current time (e.g., if a time period between the resumption time and the current time is not shorter than a threshold), the content acquiring apparatus 2a sends the delivery request for the content A to another content delivery apparatus based on the other content holding information.

For example, the content acquiring apparatus 2a sends the delivery request for the content A to the content delivery apparatus 4b based on the content holding information “T002”.

On that occasion, the content acquiring apparatus 2a requests the content delivery apparatus 4a to cancel the delivery of the content A.

On the other hand, if the content acquiring apparatus 2a determines that a resumption time is close to the current time (e.g., if the time period between the resumption time and the current time is shorter than a threshold), the content acquiring apparatus 2a stands by until the delivery of the content A from the content delivery apparatus 4a is resumed.

After stopping the delivery of the content A, the content delivery section 44a reads out the content B from the content recording section 41a and then delivers the read-out content B to the content acquiring apparatus 2b which has sent the delivery request for the content B.

After completion of the delivery of the content B to the content acquiring apparatus 2b, the content delivery section 44a resumes the delivery of the content A to the content acquiring apparatus 2a from the point at which the delivery of the content A has been stopped.

While, in the foregoing, the content delivery section 44a stops the delivery of the content A when the delivery request accepting section 42a accepts the delivery request for the content B from the content acquiring apparatus 2b, processing procedures are not limited to the above-described embodiment.

For example, when the delivery of the content A is expected to be completed in a short time, the content delivery section 44a may continue the delivery of the content A.

Also, as another example, when a given time has lapsed from the time at which the delivery request accepting section 42a has accepted the delivery request for the content A from the content acquiring apparatus 2a, the content delivery section 44a may continue the delivery of the content A.

When the content delivery apparatus 4 has deleted the content recorded in the content recording section 41, the content delivery apparatus 4 notifies the deletion of the relevant content to the content management apparatus 3.

In accordance with the notification from the content delivery apparatus 4, the related information updating section 34 of the content management apparatus 3 subtracts “1” from the number of content holding apparatuses, which is recorded in the content related information recording section 33.

Thus, the latest number of content holding apparatuses is always recorded in the content related information recording section 33.

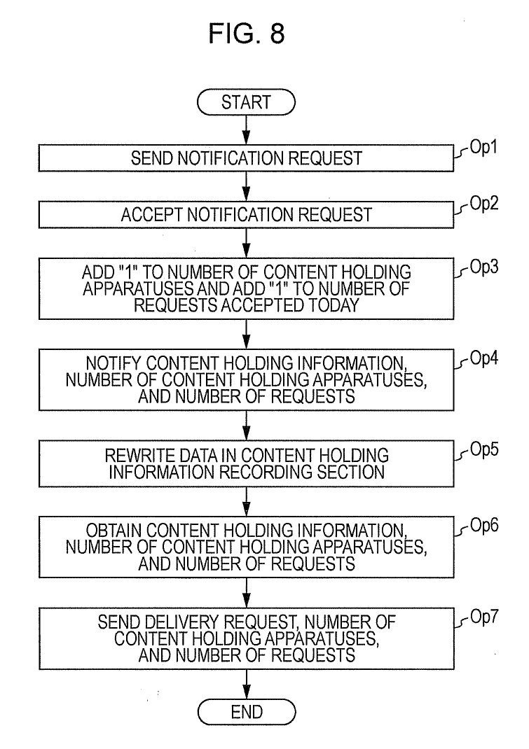

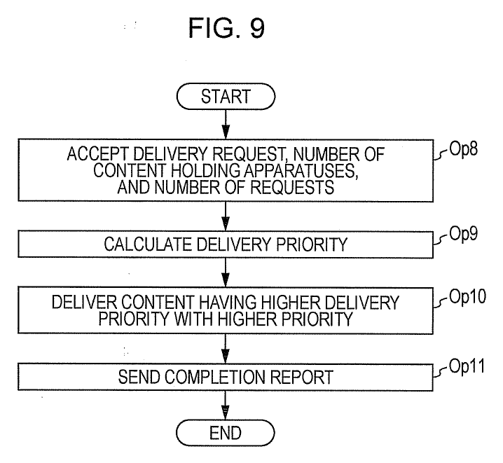

The operation of the P2P system 1 having the above-described configuration is described below with reference to FIGS. 8 and 9.

FIG. 8 is a flowchart illustrating an example of operation of the P2P system 1 including from sending of a notification request from the content acquiring apparatus 2 to the content management apparatus 3 to sending of a delivery request from the content acquiring apparatus 2 to the content delivery apparatus 4.

As illustrated in FIG. 8, the content acquiring apparatus 2 sends the request for notifying the content holding information to identify the content delivery apparatus, which holds the desired content, to the content management apparatus 3 through the network N (Operation Op1).

Then, the notification request accepting section 31 of the content management apparatus 3 accepts the notification request (Operation Op2), which has been sent in Operation Op1.

In accordance with the notification request accepted in Operation Op2, the related information updating section 34 adds “1” to the number of content holding apparatuses and also adds “1” to the number of requests accepted today, which are recorded in the content related information recording section 33 (Operation Op3).

Further, the content holding information notifying section 35 reads out, from the content holding information recording section 32, an arbitrary number of sets of the content holding information which are recorded in the content holding information recording section 32.

The content holding information notifying section 35 notifies, to the content acquiring apparatus 2 having sent the notification request in Operation Op1, the read-out content holding information along with the number of content holding apparatuses and the numbers of requests, which are recorded in the content related information recording section 33a (Operation Op4).

As a result, the content acquiring apparatus 2 having obtained the content holding information can confirm which one or more of the content delivery apparatuses hold the relevant content on the P2P system 1.

Further, the content holding information notifying section 35 rewrites data in the content holding information recording section 32 so that the terminal ID of the content acquiring apparatus 2 having sent the notification request in Operation Op1 is provided as the content holding information (Operation Op5).

Then, the content acquiring apparatus 2 obtains the content holding information, the number of content holding apparatuses, and the number of requests (Operation Op6), which have been notified in Operation Op4.

The content acquiring apparatus 2 sends, based on the content holding information obtained in Operation Op6, a content delivery request to the content delivery apparatus 4 along with the number of content holding apparatuses and the numbers of requests, which have been obtained in Operation Op6.

FIG. 9 is a flowchart illustrating an example of operation of the P2P system 1 when the content delivery apparatus 4 has accepted the delivery request sent from the content acquiring apparatus 2.

As illustrated in FIG. 9, the delivery request accepting section 42 of the content delivery apparatus 4 accepts a plurality of delivery requests through the network N, which are sent from a plurality of content acquiring apparatuses 2, along with the respective numbers of content holding apparatuses and numbers of requests (Operation Op8).

Then, the delivery priority calculating section 43 calculates delivery priority (Operation Op9), which is calculated by dividing a number of requests by a number of content holding apparatuses, for each of the contents indicated by the plurality of delivery requests, which have been accepted in Operation Op8.

Concretely, the delivery priority calculating section 43 calculates the delivery priority in accordance with the above-mentioned formula (1).

Further, the content delivery section 44 delivers the content having higher delivery priority with higher priority (Operation Op10).

Next, the content acquiring apparatus 2 having acquired the content delivered in Operation Op10 sends, to the content management apparatus 3, a completion report indicating that the acquisition of the content has completed (Operation Op11).

With the content delivery apparatus 4 according to this embodiment, as described above, the delivery priority calculating section 43 calculates the delivery priority, which is obtained based on a value calculated by dividing the number of requests by the number of content holding apparatuses, with respect to the content for which the delivery request accepting section 42 has accepted the delivery request.

In other words, the delivery priority becomes higher as the number of requests increases relative to the number of content holding apparatuses.

When the delivery request accepting section 42 accepts the delivery requests for a plurality of contents, the content delivery section 44 delivers the plurality of contents successively from the content having the highest delivery priority in the descending order of the priority.

Thus, since the content for which the number of requests is larger relative to the number of content holding apparatuses is delivered with higher priority when the delivery request accepting section 42 accepts the delivery requests for the plurality of contents, the delivery efficiency in the entire P2P system 1 can be increased.

In the above-described embodiment, the delivery priority calculating section 43 calculates the delivery priority by dividing the number of requests for three days (i.e., today, yesterday, and the day before yesterday) by the number of content holding apparatuses.

In contrast, another embodiment represents an example in which the delivery priority calculating section 43 calculates a delivery priority by dividing a number of requests, accepted from the content acquiring apparatuses 2 which are currently in a state of acquiring the content, by a number of content holding apparatuses.

Stated another way, the term “number of requests” refers to a number of times that the content management apparatus 3 has accepted the notification requests from the content acquiring apparatuses 2, for which it does not yet received the completion reports from the content acquiring apparatuses 2 in spite of having accepted the notification requests from the relevant content acquiring apparatuses.

Accordingly, the delivery priority calculating section 43 in the first modification calculates the delivery priority in accordance with a formula (2) given below.

As a result, the delivery priority calculating section 43 in the first modification can calculate the delivery priority based on the number of requests corresponding to the content acquiring apparatuses which are currently actually going to acquire the content.

Delivery priority=(number of requests accepted from the content acquiring apparatuses 2 which are currently in the state of acquiring the content)÷(number of content holding apparatuses) (2)

In the above-described embodiment, the content acquiring apparatus 2 obtains the content related information (i.e., a number of content holding apparatuses and a number of requests) from the content management apparatus 3, and the content delivery apparatus 4 obtains that content related information from the content acquiring apparatus 2.

However, processing procedures are not limited to the above-described embodiment. For example, when the content delivery apparatus 4 accepts the content delivery request from the content acquiring apparatus 2, the content delivery apparatus 4 may directly obtain the content related information from the content management apparatus 3.

The content management apparatus 3 may have the function of, when the content related information recorded in the content related information recording section 33 is updated, notifying the updated content related information (i.e., the number of content holding apparatuses and the number of requests) to the content delivery apparatus 4.

Concretely, the content management apparatus 3 notifies the updated content related information to the content delivery apparatus 4 when the number of content holding apparatuses or the number of requests is changed (updated) in excess of a certain threshold.

In that case, the delivery priority calculating section 43 of the content delivery apparatus 4 calculates the delivery priority based on the content related information notified from the content management apparatus 3.

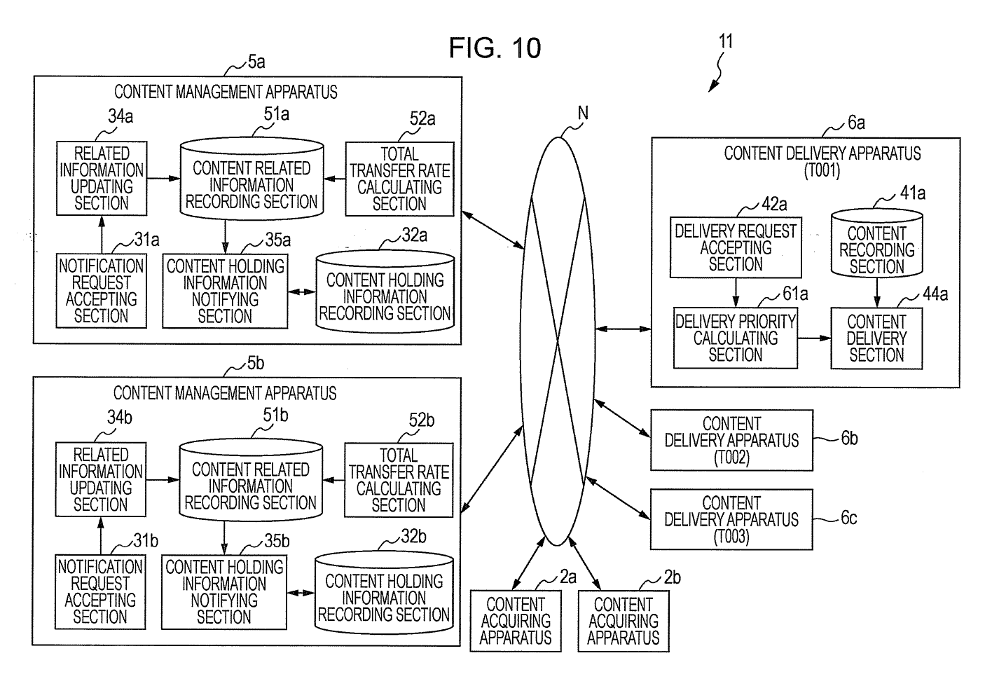

FIG. 10 is a block diagram of a P2P system 11 according to an embodiment.

Note that, in FIG. 10, components having similar functions to those in FIG. 1 are denoted by the same reference characters, and a detailed description thereof is omitted here.

A content management apparatus 5 includes a content related information recording section 51 instead of the content related information recording section 33 illustrated in FIG. 1.

Further, the content management apparatus 5 includes a total delivery rate calculating section 52 in addition to the configuration of the content management apparatus 3 illustrated in FIG. 1.

The content related information recording section 51 records therein content related information.

Herein, the content related information includes a total delivery rate which represents a total of respective content delivery rates (transfer rates) of the content delivery apparatuses holding the same content on the network N, and a number of requests, which represents a number of times that the notification request accepting section 31 has accepted inquiries regarding content holding statuses from the content acquiring apparatuses 2.

In an embodiment, a total delivery rate is calculated as a total sum of respective content delivery rates of a plurality of content delivery apparatuses corresponding respectively to plural sets of the content holding information.

The term “number of requests” used in an embodiment refers to a number of times that the notification request accepting section 31 has accepted the notification requests from the content acquiring apparatuses 2 within a given period.

While, also in an embodiment, the given period is three days, i.e., today, yesterday, and the day before yesterday, it is a matter of courts that the given period is not limited to those three days.

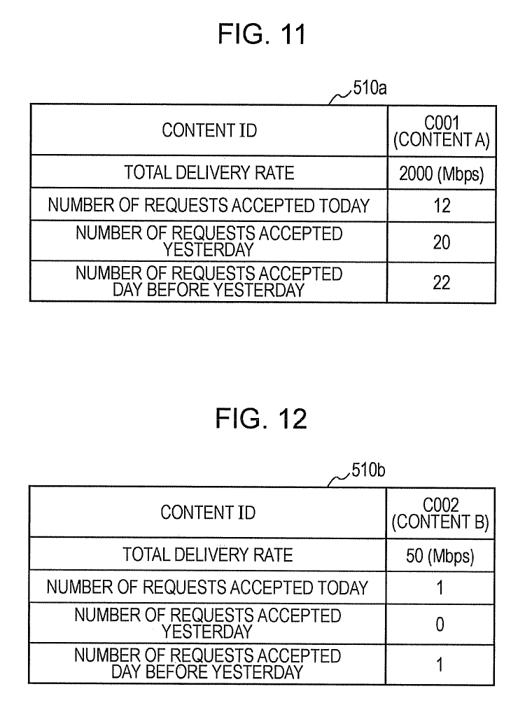

FIG. 11 illustrates one example of content related information recorded in a content related information recording section 51a of a content management apparatus 5a according to an embodiment.

More specifically, the content related information recording section 51a according to an embodiment records the content related information in the form of a table 510a.

As illustrated in FIG. 11, the table 510a records the content ID “C001” of the content A, the total delivery rate of “2000” (Mbps), the number “12” of requests accepted today, the number “20” of requests accepted yesterday, and the number “22” of requests accepted the day before yesterday.

The total delivery rate of “2000” (Mbps) in an embodiment is a total sum of respective content delivery rates of a plurality of content delivery apparatuses corresponding respectively to plural sets of the content holding information, which are recorded in the content holding information recording section 32a.

FIG. 12 illustrates one example of content related information recorded in a content related information recording section 51b of a content management apparatus 5b according to an embodiment.

More specifically, the content related information recording section 51b according to this embodiment records the content related information in the form of a table 510b.

As illustrated in FIG. 12, the table 510b records the content ID “C002” of the content B, the total delivery rate of “50” (Mbps), the number “1” of requests accepted today, the number “0” of requests accepted yesterday, and the number “1” of requests accepted the day before yesterday.

The total delivery rate of “50” (Mbps) in an embodiment is a total sum of respective content delivery rates of a plurality of content delivery apparatuses corresponding respectively to plural sets of the content holding information, which are recorded in the content holding information recording section 32b.

The total delivery rate calculating section 52 first obtains, from a plurality of content delivery apparatuses, a respective content delivery rates of the plurality of content delivery apparatuses corresponding respectively to plural sets of the content holding information, which are recorded in the content holding information recording section 32.

In other words, the plurality of content delivery apparatuses previously record the respective content delivery rates which have been measured by the plurality of content delivery apparatuses themselves.

The total delivery rate calculating section 52 calculates a total delivery rate by totalizing the obtained respective content delivery rates.

The total delivery rate calculating section 52 records a calculated total delivery rate in the content related information recording section 51.

A content delivery apparatus 6 includes a delivery priority calculating section 61 instead of the delivery priority calculating section 43 illustrated in FIG. 1.

The delivery priority calculating section 61 calculates delivery priority, which is obtained based on a value calculated by dividing a number of requests by a total delivery rate, with respect to the content for which the delivery request accepting section 42 has accepted the delivery request.

More specifically, the delivery priority calculating section 61 calculates the delivery priority in accordance with a formula (3) given below.

In other words, the delivery priority expressed by the following formula (3) becomes higher as a number of requests increases relative to the total delivery rate.

Alternatively, the delivery priority may be calculated by multiplying the following formula (3) by some coefficient (correction coefficient).

Delivery priority=(number of requests accepted today+number of requests accepted yesterday+number of requests accepted the day before yesterday)÷(total delivery rate) (3)

With the content delivery apparatus 6 according to this embodiment, as described above, the delivery priority calculating section 61 calculates the delivery priority, which is obtained based on a value calculated by dividing the number of requests by the total delivery rate, with respect to the content for which the delivery request accepting section 42 has accepted the delivery request.

In other words, the delivery priority becomes higher as a number of requests increases relative to a total delivery rate.

When the delivery request accepting section 42 accepts the delivery requests for a plurality of contents, the content delivery section 44 delivers the plurality of contents successively from the content having the highest delivery priority in the descending order of the priority.

Thus, since the content for which the number of requests is larger relative to the total delivery rate is delivered with higher priority when the delivery request accepting section 42 accepts the delivery requests for the plurality of contents, the delivery efficiency in the entire P2P system 11 can be increased.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A content delivery apparatus operable to access a network with which a content management apparatus and a content acquiring apparatus are connected, the content delivery apparatus comprising:
a content recording section in which one or more contents are recorded;
a delivery request accepting section for accepting a content delivery request from the content acquiring apparatus;
a delivery priority calculating section for obtaining, from the content management apparatus or the content acquiring apparatus, a number of content holding apparatuses representing a number of content delivery apparatuses having the same content on the network, and a number of requests indicating a number of times the content management apparatus has accepted inquiries regarding content holding statuses from the content acquiring apparatuses, and for calculating a delivery priority by dividing the number of requests by the number of content holding apparatuses, with respect to the content for which the delivery request accepting section has accepted the delivery request; and
a content delivery section for, when the delivery request accepting section accepts the delivery requests for a plurality of contents, delivering the plurality of contents preferentially from a content having a high delivery priority.

2. A content delivery apparatus operable to access a network with which a content management apparatus and a content acquiring apparatus are connected, the content delivery apparatus comprising:
a content recording section in which one or more contents are recorded;
a delivery request accepting section for accepting a content delivery request from the content acquiring apparatus;
a delivery priority calculating section for obtaining, from the content management apparatus or the content acquiring apparatus, a total delivery rate representing a total of respective content delivery rates of content delivery apparatuses recording the same content on the network, and a number of requests indicating a number of times that the content management apparatus has accepted inquiries regarding content holding statuses from the content acquiring apparatuses, and for calculating a delivery priority by dividing the number of requests by the total delivery rate, with respect to the content for which the delivery request accepting section has accepted the delivery request; and
a content delivery section for, when the delivery request accepting section accepts the delivery requests for a plurality of contents, delivering the plurality of contents preferentially from a content having a high delivery priority.

3. The content delivery apparatus according to claim 1, wherein the content acquiring apparatus having acquired the content delivered from the content delivery section sends a completion report indicating completion of acquisition of the content, to the content management apparatus to which the inquiry regarding the content holding status has been sent from a relevant content acquiring apparatus, and
wherein the number of requests represents the number of times that the content management apparatus has accepted the inquiries regarding the content holding statuses from the content acquiring apparatuses, for which the content management apparatus has not yet received completion reports from the content acquiring apparatuses in spite of having accepted the inquiries from relevant content acquiring apparatuses.

4. A communication system including a content management apparatus, a content acquiring apparatus, and a content delivery apparatus which are connected with a network,
the content management apparatus recording a number of content holding apparatuses representing a number of content delivery apparatuses recording the same content on the network, and a number of requests indicating a number of times that the content management apparatus has accepted inquiries regarding content holding statuses from the content acquiring apparatuses, and
the content delivery apparatus includes:
a content recording section in which one or more contents are recorded;
a delivery request accepting section for accepting a content delivery request from the content acquiring apparatus;
a delivery priority calculating section for obtaining, from the content management apparatus or the content acquiring apparatus, a number of content holding apparatuses and a number of requests which are recorded in the content management apparatus, and for calculating a delivery priority by dividing the number of requests by the number of content holding apparatuses, with respect to the content for which the delivery request accepting section has accepted the delivery request; and
a content delivery section for, when the delivery request accepting section accepts the delivery requests for a plurality of contents, delivering the plurality of contents preferentially from a content having a high delivery priority.

5. A communication system including a content management apparatus, a content acquiring apparatus, and a content delivery apparatus which are connected with a network,
the content management apparatus records a total delivery rate which represents a total of respective content delivery rates of content delivery apparatuses recording the same content on the network, and a number of requests indicating a number of times that the content management apparatus has accepted inquiries regarding content holding statuses from the content acquiring apparatuses, and
the content delivery apparatus includes:
a content recording section in which one or more contents are recorded;
a delivery request accepting section for accepting a content delivery request from the content acquiring apparatus;
a delivery priority calculating section for obtaining, from the content management apparatus or the content acquiring apparatus, a total delivery rate and a number of requests which are recorded in the content management apparatus, and for calculating a delivery priority by dividing the number of requests by the total delivery rate, with respect to the content for which the delivery request accepting section has accepted the delivery request; and
a content delivery section for, when the delivery request accepting section accepts the delivery requests for a plurality of contents, delivering the plurality of contents preferentially from a content having a high delivery priority.

6. A content delivery method with processing executed by a content delivery apparatus connected to a network with which a content management apparatus and a content acquiring apparatus are connected, the content delivery apparatus being capable of accessing a content recording section in which one or more contents are recorded in advance, the method comprising:
accepting a delivery request by the content delivery apparatus, and accepting a content delivery request from the content acquiring apparatus;
obtaining, from the content management apparatus or the content acquiring apparatus, a number of content holding apparatuses representing a number of content delivery apparatuses recording the same content on the network, and a number of requests indicating a number of times that the content management apparatus has accepted inquiries regarding content holding statuses from the content acquiring apparatuses, and
calculating a delivery priority by dividing the number of requests by the number of content holding apparatuses, with respect to the content for which the delivery request has been accepted; and
delivering a plurality of contents preferentially from a content having a high delivery priority when the delivery requests for the plurality of contents are accepted.

7. A content delivery method with processing executed by a content delivery apparatus connected to a network with which a content management apparatus and a content acquiring apparatus are connected, the content delivery apparatus being capable of accessing a content recording section in which one or more contents are recorded, the method comprising:
accepting, by a delivery request accepting section of the content delivery apparatus, a content delivery request from the content acquiring apparatus;
obtaining, from the content management apparatus or the content acquiring apparatus, a total delivery rate representing a total of respective content delivery rates of content delivery apparatuses recording the same content on the network, and a number of requests indicating a number of times that the content management apparatus has accepted inquiries regarding content holding statuses from the content acquiring apparatuses, and
calculating a delivery priority by dividing the number of requests by the total delivery rate, with respect to the content for which the delivery request has been accepted; and
delivering the plurality of contents preferentially from a content having a high delivery priority by a content delivery section of the content delivery apparatus when the delivery requests for a plurality of contents are accepted.

8. A computer-readable medium storing a program for a content delivery apparatus operable to access a network with which a content management apparatus and a content acquiring apparatus are connected, the content delivery apparatus being capable of accessing a content recording section in which one or more contents are recorded, the program causing the content delivery apparatus to execute:
accepting a content delivery request from the content acquiring apparatus;
obtaining, from the content management apparatus or the content acquiring apparatus, a number of content holding apparatuses, representing a number of content delivery apparatuses recording the same content on the network, and a number of requests indicating a number of times that the content management apparatus has accepted inquiries regarding content holding statuses from the content acquiring apparatuses, and
calculating a delivery priority, by dividing the number of requests by the number of content holding apparatuses, with respect to the content for which the delivery request has been accepted; and
delivering a plurality of contents delivering the plurality of contents preferentially from a content having a high delivery priority when the delivery requests for a plurality of contents are accepted.

9. A computer-readable medium storing a program for a content delivery apparatus operable to access a network with which a content management apparatus and a content acquiring apparatus are connected, the content delivery apparatus being capable of accessing a content recording section in which one or more contents are recorded, the program causing the content delivery apparatus to execute an operation, comprising:
accepting a content delivery request from the content acquiring apparatus;
obtaining, from the content management apparatus or the content acquiring apparatus, a total delivery rate representing a total of respective content delivery rates of content delivery apparatuses recording the same content on the network, and a number of requests indicating a number of times that the content management apparatus has accepted inquiries regarding content holding statuses from the content acquiring apparatuses, and
calculating a delivery priority by dividing the number of requests by the total delivery rate, with respect to the content for which the delivery request has been accepted; and
delivering the plurality of contents preferentially from a content having a high delivery priority when the delivery requests for a plurality of contents are accepted.

10. A computer-implemented method, comprising:
determining a number of requests for content and a number of locations holding the content; and
calculating a delivery priority for requests pertaining to the content based on said determining and delivering the content using the delivery priority calculated starting from a content having a highest delivery priority.
